(19) United States
(12) Patent Application Publication
(10) Pub. No.: US 2017/0001322 A1
(43) Pub. Date: Jan. 5, 2017

(54) PORTABLE DISPOSABLE FLUID DISPENSING HAIR REMOVAL DEVICE

(71) Applicant: The Gillette Company, Boston, MA (US)

(72) Inventors: Anthony William Shorey, Thatcham (GB); Nicola Louise Caton, Reading (GB); Lottie Hannah Duke, Bath (GB)

(21) Appl. No.: 15/193,194

(22) Filed: Jun. 27, 2016

(30) Foreign Application Priority Data
Jun. 30, 2015 (EP) 15174580.9

(51) Int. Cl. B26B 21/44; B26B 21/52

(52) U.S. Cl. CPC B26B 21/446; B26B 21/522

(57) ABSTRACT

The present invention relates to a hair removal and fluid application device (1), having head portion (9) having a hair removal means (2), and a handle having a fluid reservoir (10) and a fluid dispensing means (3). The head portion has a storage configuration and an in use configuration.

### FIELD OF THE INVENTION

The invention relates to disposable fluid dispensing hair removal devices which enable a consumer to conduct a hair removal process without the need for additional system components which is low cost and simple to manufacture and convenient to use, particularly in the absence of a source of water and or outside of a bathroom environment and is readily portable.

### BACKGROUND OF THE INVENTION

Reusable hair removal devices which are also capable of dispensing a fluid are known in the art. Such devices, typically include one or more fluid dispensing orifices through which the fluid is dispensed via the razor cartridge during the shaving process. The fluid is contained with a replaceable reservoir located in the handle and is activated by a push button. Such devices are complex to manufacture requiring many parts and are designed to enable the replacement of both the razor cartridge and fluid reservoir. For example see U.S. 2013/0145626, U.S. 2013/0145625, U.S. 2013/0145601 and WO 2011/130372.

Disposable hair removal devices whereby the razor cartridge cannot be replaced, are also well known in the art. These devices are typically slightly less complex versions of reusable devices, for example by the removal of the pivot between the cartridge and handle, to thereby simplify and reduce the costs of manufacturing. Nevertheless, these devices are still considerably complex to manufacture.

Hence, there is still a need to provide a disposable hair removal device which also enables the dispensation of a fluid and thereby negates the need for a separate fluid container while reducing the complexity of the device and number of components thereof, to reduce the cost of manufacture. This is particularly desirable for hair removal processes which take place away from the consumers' home bathroom facilities such as while traveling and or in the absence of a convenient water supply. There is also a need to provide a device which is easy to effectively use for all body areas.

Attempts have been described in the art to provide disposable hair removal devices which also dispense a fluid. For example EP 427889A describes a disposable razor with detachable gel packets secured to the razor handle whereby the packets can be removed from the razor, opened and the contents applied to the skin prior or after the shaving process. This device is not particularly convenient for the consumer as the packets require removal from the device and separate independent application of the fluid. DE 102011117590 describes a disposable razor comprising a removable container for a shaving gel. The shaving gel container is placed on the razor handle and the end is placed on the razor head. Upon applying pressure to the perforations on the container the container is opened to release the razor gel.

US2004/0016126 describes a manually adjustable hair removal and skin lubrication device. The device has a U shaped body which can be manipulated to expel lubricant from the internal reservoir independently or simultaneously during the hair removal process. This device however requires a significant amount of manual dexterity in order to select the desired usage configuration and in particular, to consistently maintain the desired configuration in order to simultaneously dispense the lubricant and control the razor cartridge during the entire shaving process. The consumer is therefore required to continuously check the configuration and this is particularly inconvenient as it results in an interruption of the shaving process and is impractical when shaving more inaccessible body areas. Moreover, the lubricant and wicking device are not sealed prior to use and thereby are liable to inadvertent spillage and or contamination.

Despite the availability of fluid dispensing razors, many consumers however still prefer to apply a skin preparation treatment onto the skin prior to the shaving process even if using a liquid dispensing razor. Liquid dispensing razors typically dispense the liquid directly below or above the razor blades or from within the razor cartridge through the razor blades. Consequently, the consumer may not be able to visibly confirm that the liquid has been dispensed on the skin surface to be shaved. The use of the pre-shaving preparation reassures and confirms to the consumer that there is complete and thorough coverage of the skin with the skin preparation prior to shaving. Moreover, the skin is hydrated and lubricated prior to shaving which improves the shaving experience. Similarly, the removal of the composition from the skin following the shave provides an indication to the consumer as to which areas have been shaved.

In order to facilitate the use of such disposable fluid dispensing hair removal devices away from the bathroom environment, there also exists a need to provide such devices in a portable and compact configuration such that the hair removal and fluid dispensing means do not inadvertently injure the user or cause damage to the user's personal effects when not in use.

Consequently, there still exists a need to provide a cost effective, disposable fluid dispensing hair removal device which enables the application of a pre shave or post shave composition in a simple and convenient manner which is easy to use and does not require any manual dexterity and which can be used for all body areas. There is also a need to provide a device which does not require expensive tooling or molding equipment. There is also a need to provide a device which is easily transportable and compact so as to be readily used away from home.

It has now been surprisingly found that disposable hair removal and fluid dispensing devices which are cheap and easy to manufacture, and which do not necessarily require expensive tooling equipment, but deliver the desired level of functionality of the consumer products can be provided by a device having a head portion having a hair removal means and fluid dispensing means wherein the head portion has an in use configuration and a storage configuration.

### SUMMARY OF THE INVENTION

The present invention relates to a portable hair removal and fluid application device having a head portion comprising a hair removal means, and a handle having a fluid reservoir; and a fluid dispensing means, wherein said head portion has a storage configuration and an in use configuration, wherein in said storage configuration said head portion is positioned adjacent said handle and substantially parallel thereto and in said in use configuration said head portion is positioned substantially perpendicular to said handle.

In a further aspect the invention relates to a method to dispense fluid and remove hair with a device (1) according to the invention of claim 1, comprising the steps of positioning said device (1) in its in use configuration and then contacting a skin surface first with said hair removal means (2) to remove hair and then contacting a skin surface with said fluid dispensing means (3) to apply fluid or vice versa, preferably in the absence of a source of water.

### BRIEF DESCRIPTION OF THE DRAWINGS

FIGS. 1a and 1b shows perspective views of a first embodiment of the invention with a protective cover and showing the cover partially removed.

FIG. 2 shows a schematic view of the conversion of the storage configuration to the in use configuration of the first embodiment.

FIGS. 3a and 3b shows a front perspective view of the first embodiment and a cross section of the first embodiment.

FIGS. 4a and 4b shows perspective front and rear views of a second embodiment of the invention.

FIGS. 5a and 5b shows a schematic view of the removal of the protective cover of the second embodiment.

FIGS. 6a and 6b shows a schematic view of the conversion from the storage configuration and in use configuration of the second embodiment.

FIGS. 7a and 7b shows a cross section and an exploded view of the cross section of the second embodiment.

### DETAILED DESCRIPTION OF THE INVENTION

According to the invention the hair removal and fluid application device (1) comprises a head portion (9) having a hair removal means (2) and a handle (4) having a fluid reservoir (10) and wherein the device has a fluid dispensing means (3) preferably on the head portion (9).

Hair Removal Means

Any hair removal means (2) known in the art may be used herein, such as single or multiple, i.e. at least two blades, or three blades and optionally an associated razor housing or cartridge there for; foil, scraper or mesh. Preferably, the hair removal means comprises a guard and a cap with at least one blade located in-between the cap and guard. More preferably, the hair removal means (2) comprises a razor cartridge having a housing and a cap and a guard located on the housing and at least one blade(s) positioned between the cap and guard. Embodiments of this type having a single blade cartridge are particularly beneficial as they allow shaving debris such as hair, skin and shaving composition to readily pass through the cartridge and thereby prevent clogging.

Fluid Dispensing Means

Suitable fluid dispensing means (3) include any material capable of dispensing the fluid upon application of the means against a user's skin. The rate of dispensing can be readily controlled by the consumer by regulating the amount of pressure applied to the dispensing means against the user's skin.

Suitable materials include foams, including open and closed cell foams, wovens, nonwovens, pressed porous fibers such as felt, single or multiple perforated or apertured films, rigid or semi rigid molded plastic and combinations thereof. The fluid dispensing means may comprise a single layer or multiple layers of material which may be the same material or different. Such layered embodiments may be layered vertically on top of one another whereby each layer extends towards the surface facing the skin contacting surface or layered adjacent one another each layer directly facing the skin contacting surface. Alternatively the fluid dispensing means may be a roller ball or brush.

Preferably, the hair removal means (3) is provided by a foam, more preferably an open celled foam. Suitable materials include natural sponge, cellulose, polyethylene, polyurethane and other synthetic foam materials known in the art and commercially available. Foam materials are particularly advantageous as they may function to both retain, dispense and spread the fluid dispensed onto the skin, thereby enabling a more controlled application of the fluid onto the user's skin by the consumer.

In one preferred embodiment, the fluid dispensing means is selected such that it may also function as a post hair removal debris collector so that it will act to collect at least some of the hair and or fluid remaining on the skin after the hair removal process. Suitable materials for such embodiments include foams preferably open celled cellulose foams. Alternatively a combination of materials may be utilized in order to provide both fluid dispensing and debris collection. Suitable combinations include for example open and closed cell foams, or a foam and non woven sheet material composite.

The fluid dispensing means preferably has a skin contacting surface area of from about 0.8 cm² to about 35 cm², preferably from about 5 cm² to about 15 cm², more preferably from about 8 cm² to about 10 cm².

The fluid dispensing means may be provided with at least one aperture or opening or channel in fluid communication with the reservoir as discussed hereinafter.

Head Portion

The hair removal and fluid application device (1) comprises a head portion (9). The hair removal means (2) and preferably the fluid dispensing means (3) are located on the head portion (9) of the device. The head portion (9) has a front surface and a back surface. In one embodiment the hair removal means (2) and fluid dispensing means (3) may be located on the front and back surfaces respectively or may be both positioned on the front or back surfaces. In another embodiment the hair removal means (2) and the fluid dispensing means (3) are located on opposing surfaces i.e. front and back surfaces respectively of the head portion (9). In another embodiment the hair removal means and fluid dispensing means each have a respective skin contacting surface, wherein the skin contacting surface of the hair removal means is positioned substantially in the opposing direction to the skin contacting surface of the fluid dispensing means. This enables the hair removal means and the fluid dispensing means to be contained on a single device but used independently from one another without any interference, thereby enabling the consumer to effectively apply the fluid composition to the desired body surfaces before or after use of the hair removal device. The hair removal means (2) and the fluid dispensing means (3) may be positioned such that they are substantially aligned about a horizontal plane. Alternatively, the hair removal means and the fluid dispensing means may be offset. The head portion (9) preferably provides a predetermined location of the hair removal means (2) and the fluid application means (3).

The fluid dispensing means (3) and hair removal means (2) are preferably independently attached or secured to the head portion (9) of the device (1). Suitable securing means include adhesives, ultrasonic welding, double sided tape, rivets, clips or other mechanical means and combinations thereof. The attachment of the fluid dispensing means (3) and the hair removal means (2) may be permanent or releasable to the head portion (2) to enable replacement thereof.

In one embodiment, the fluid dispensing means (3) and or hair removal means (2) independently extend along at least a portion, preferably at least 50% more preferably at least 75%, even more preferably at least 90% of the width of the head portion. In another embodiment the fluid dispensing means (3) and or hair removal means (2) independently extend along at least 95%, preferably at least 99% of the width of the head portion.

Storage and in Use Configuration

The head portion (9) of the device may be releasably or permanently attached to the handle (4) of the device in one of two configurations which are interchangeable; namely a storage configuration and an in use configuration. In the storage configuration, the head portion is positioned adjacent said handle and substantially parallel thereto. The head portion is thereby substantially aligned with the handle and results in an overall linear configuration which is both compact and prevents inadvertent damage to the head portion and its components and the user's personal possessions when in transit. The releaseable attachment of the handle (4) to the head portion (9) may also facilitate replacement thereof. The storage position of the head portion may be further secured to prevent inadvertent conversion to the in use position by the use of a cap and or cover as described herein after.

The head portion (9) further has an in use configuration wherein the head portion is positioned substantially perpendicular to said handle (4). In this configuration the head portion (9) adopts a traditional T bar configuration to enable optimal hair removal and fluid application by the user.

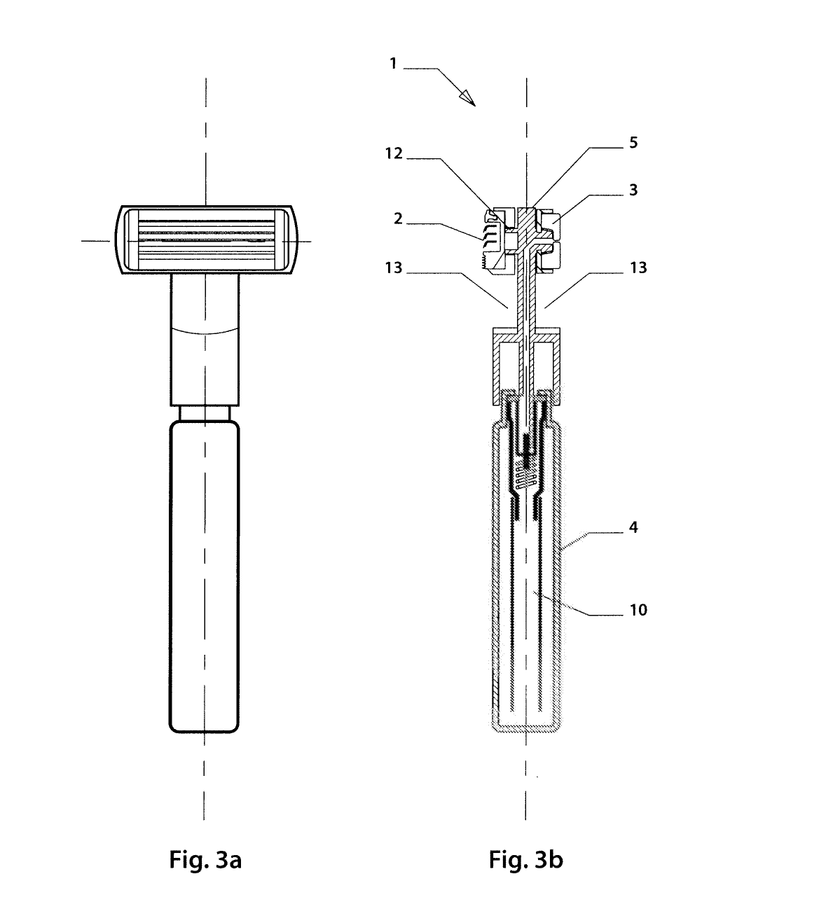

In one embodiment, the head portion (9) is movably but preferably permanently attached to the handle (4) about a pivot point (12). Typically, the head portion is rotatable about a pivot point (12) located on the handle (4) to rotate the head portion (9) between the in use configuration and the storage configuration and vice versa. Preferably the pivot point (12) is positioned at substantially the longitudinal midpoint of said head portion. The pivot point (12) may be located on one of the external front or rear facing surfaces of the head portion. In an alternative embodiment, the pivot point (12) and associated attachment means to the handle (4) may be located in the interior of the head portion. In such embodiments, in order to enable the head portion (9) to rotate about the pivot point (12) from the in use configuration to the storage configuration and vice versa, the head portion and or handle may be provided with a cavity or recess (13) extending from one end of the head portion to the pivot point and or at the distal end of the handle (4). The cavity or recess (13) is sized to enable the distal portion of the handle to contain at least a portion of the head portion as shown in FIG. 3. The distal end (6) of the handle thereby may at least partially contain the head portion in the devices' in storage configuration.

The pivot may be provided with a stop to ensure that the head portion does not rotate beyond the desired in use or storage configurations.

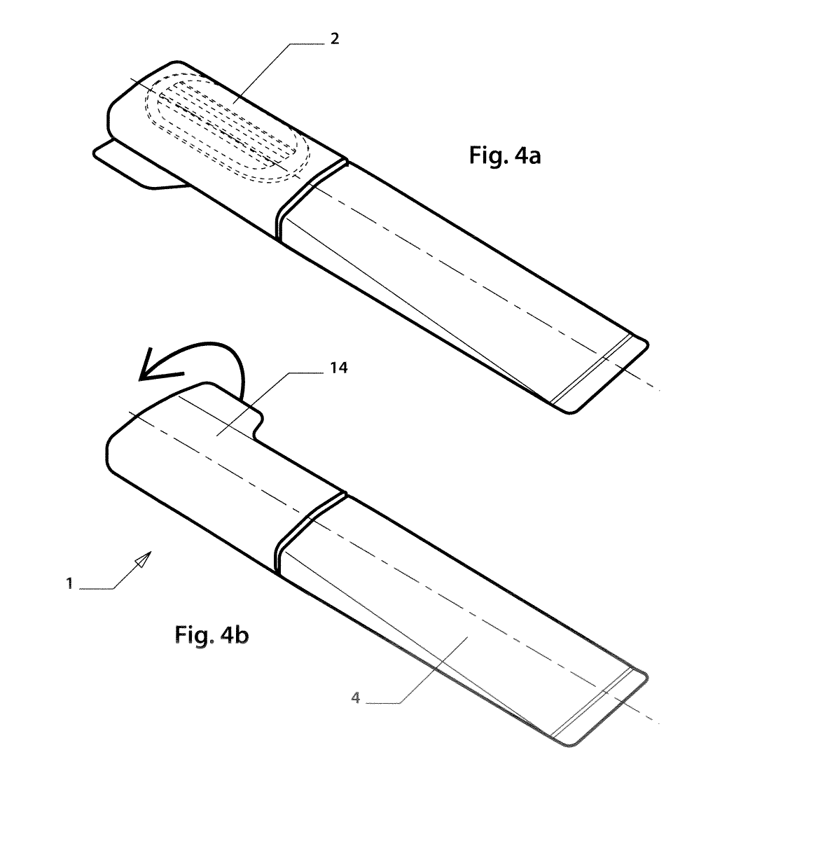

In an alternative embodiment, the head portion (9) is releasably attached to said handle (4). The head portion (9) may have an in use configuration attachment means and a storage configuration attachment means as shown in FIG. 4. Likewise the handle (4) may be provided with an in use and storage attachment means. Suitable attachment means include adhesives, double sided tape, rivets, clips or other mechanical means such as lock and key type attachment means and combinations thereof.

The head portion (9) may be provided from any suitable material such as those described hereinafter for the handle.

Handle

The hair removal and fluid application device (1) further comprises a handle (4) to enable both a user to hold and control the device and to securely locate and position the head portion in predetermined positions for usage referred to as in use configuration and for storage referred to as storage configuration. The handle (4) has a proximal end (5) and a distal end (6) and may have a major front and back surface. The handle (4) typically extends from the proximal end (5) towards the distal end (6) comprising the head portion (9). This is in order to provide a portion of the handle (4) which can be readily held and controlled by the consumer and is independent of whether the head portion is in its storage or in use configuration. In one embodiment the handle (4) has a distal end (6) and a proximal end wherein the head portion (9) is movably attached to the handle (4) at the distal end (6). Preferably the distal end (6) of the handle at least partially contains said head portion in said storage configuration.

In one embodiment of the invention the fluid dispensing means is located at the proximal end of the handle of the device which also enables independent use of the hair removal means and the fluid dispensing means. In such embodiments the fluid dispensing means may be releasably or permanently attached to the handle using means described hereinabove.

The handle (4) and the head portion (9) preferably provide sufficient rigidity to the device to enable the consumer to hold the device and apply and dispense the fluid contained in the handle or reservoir onto the skin or apply the hair removal means onto the skin.

The handle may be formed from any suitable material including natural and synthetically derived materials and combinations thereof including polymers, such as plastic, both rigid and semi rigid such as polystyrene, polypropylene, extruded and blow molded, metal and alloys, cellulose such as cardboard, paperboard, carton board and carrier board; nylon, rayon, cotton and combinations thereof. The handle may be in the form of a scaffold, cage, mesh, lattice or skeleton configuration, or in tubular form or combinations thereof optionally having openings therein. In one embodiment, the handle is substantially rigid. This may be of advantage for use in difficult to access areas or to provide neat finish to side burn and beards and to facilitate transition from the head portion storage configuration and the in use configuration for example.

According to the invention the handle (4) may be formed from carton board, preferably carrier board. The handle may be a single or multiple boards and or may be in the form of a scaffold, cage, mesh, lattice or skeleton configuration, or combinations thereof optionally having openings therein. The handle may be formed from any suitable cardboard, carrier board, carton board, paper board or liquid packaging board. Such terms are used interchangeably herein. Such boards are typically produced from cellulose fibers such as wood or plant based pulp sources included recovered fibers or waste paper. The carton board may be single or multiply. The carton board may contain pigment coating such as clay, calcium carbonate and titanium dioxide and or may contain adhesives and or binders such as styrene butadiene. The handle may preferably be surface treated on at least one major front and or rear surface with a suitable water repellant material such as a wax or polymer(s) to improve consumer handling particularly in the presence of water and to improve the tactile feel or grip of the handle and to more readily enable printing.

The material may have at least a portion which is corrugated. In one embodiment the carton board may be laminated to further improve wet strength. The handle may be formed from a single piece of material or from two or more pieces of material which are joined together using known means such as adhesive.

While not being bound by theory, the use of carton board for the handle provides a number of advantages. Carton board can be readily incorporated into a manufacturing process without the need for expensive tooling and is readily cut to the desired shape. Moreover as discussed hereinafter the desired fold lines or score lines are also readily produced in carton board. Carton board further provides a desirable thickness to strengthen ratio and density to provide a strong but lightweight handle. Consequently, the carton board handle can provide the device with the desired degree of flexibility for improved consumer usage experience while maintaining sufficient rigidity so that the consumer can exert the desired force associated with the hair removal or fluid application process as exemplified hereinafter. The carton board for use herein may have basis weight of from about 200 g/m², preferably from about 225 g/m², more preferably from about 250 g/m². The carton board may have a thickness of from about 0.25 mm, preferably from about 0.3 mm and preferably less than 1.5 mm

The handle may take any shape or configuration provided it is suitable to be held by the consumer and can secure the location of the head portion, hair removal means and the fluid dispensing means and can enable the storage and in use configuration of the head portion. Suitable configurations include substantially U shape, V shape, diamond shape, S shape substantially flat, tubular, curved shape and combinations thereof. The shape should preferably be ergonomic and enable easy handling by the consumer. Preferably the handle is in a tubular form.

At least a portion of the handle may be provided within the fluid reservoir or, integral with the reservoir. Alternatively the handle may be provided external to the reservoir. In one embodiment the handle means is external to the reservoir and partially, preferably substantially encloses the reservoir either on the major front and or rear surface. Such embodiments provide protection of the fluid reservoir from accidental rupture and enable the consumer to exert pressure onto the reservoir to expel the fluid contained therein via the handle.

In one embodiment the handle may be provided with at least one, preferably at least two predetermined fold lines (deformation lines) and or score line, typically positioned extending longitudinally from the proximal end to the distal end. The fold lines are preferably formed so as to enable the flat handle to form a 3D shape and contain the fluid reservoir enabling the consumer to readily hold the device. Alternatively the fold line(s) may provide further structure to a preformed 3D handle and or delineate or separate the hair removal means from the fluid dispensing means.

In an alternative embodiment, the handle (4) provides a hollow cavity which acts as the fluid reservoir itself without the necessity of an additional fluid reservoir. The handle (4) functions to both contain and expel the required amount of fluid and also to enable a user to hold and control the device and to securely locate and position the hair removal means (2) and the fluid dispensing means (3) onto the desired skin surface to be treated. The hollow handle (4) is sufficiently rigid to enable the user to securely hold the device but also exhibits sufficient and flexibility and preferably resiliency as a reservoir for containing fluids. This facilitates the expulsion of the fluid from the handle upon the application of pressure by the user while preferably regaining the reservoirs' original configuration after the removal of the application of pressure independent of whether the handle contains fluid or not.

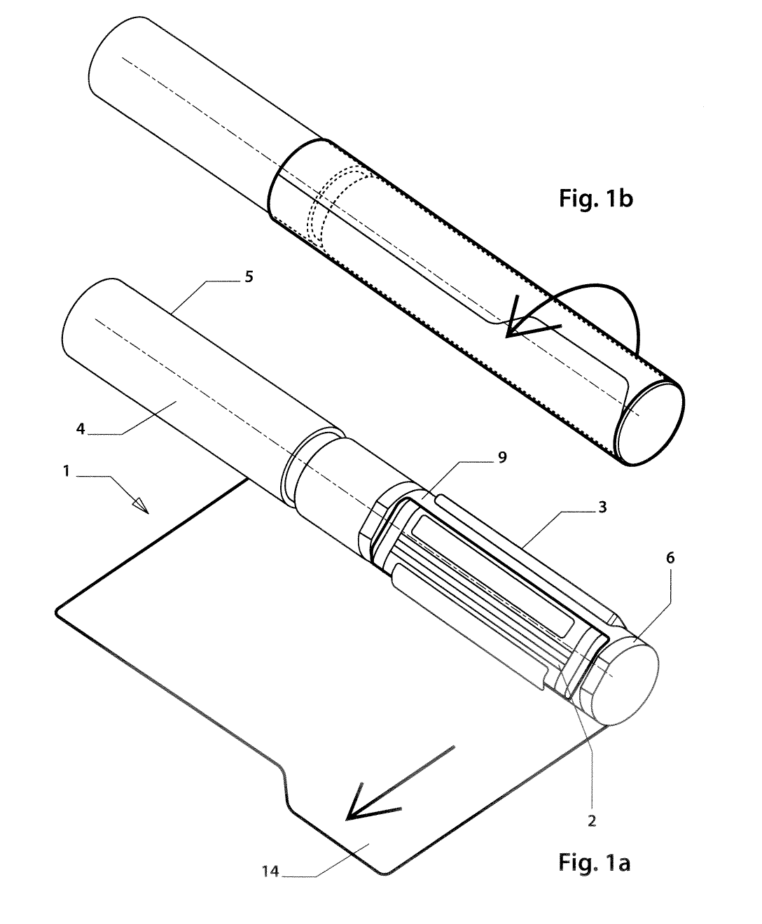

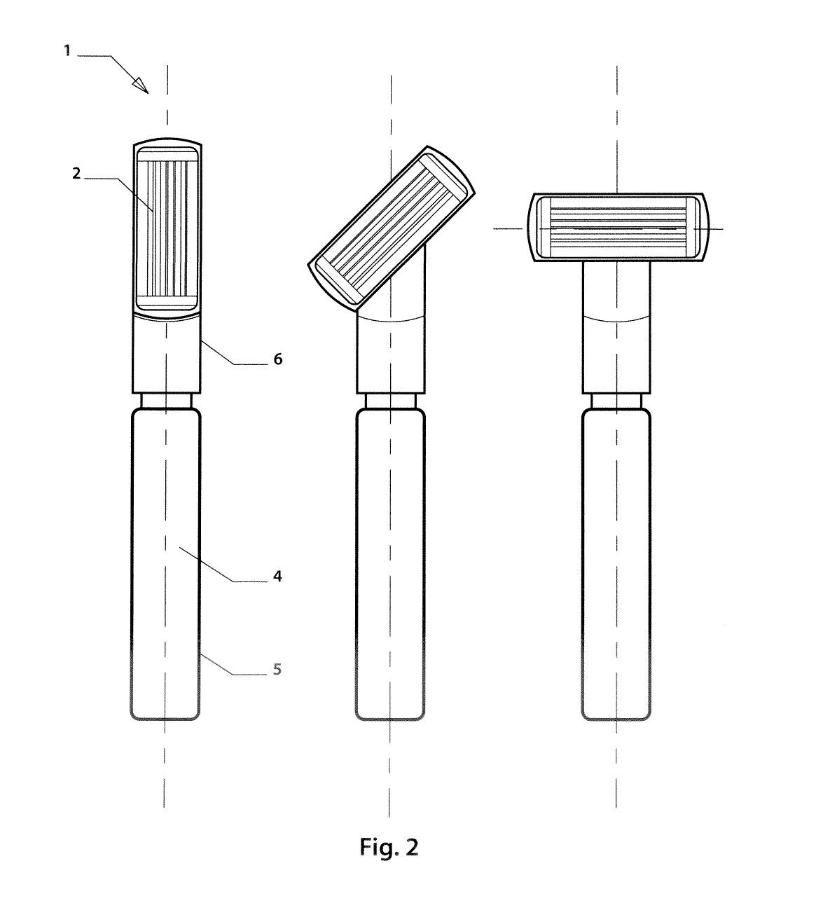

In another embodiment the handle (4) may be provided as a conventional pressurized aerosol container which provides the rigidity for consumer handling while readily containing and dispensing the fluid as shown in the first embodiment of FIGS. 1, 2 and 3.

The handle (4) typically has major front and back surfaces and optionally at least one bottom edge and at least one dispensing aperture (as discussed hereinafter). Alternatively the handle may have a substantially tubular shape. The handle (4) is preferably formed by blow molding or seamless extrusion techniques known in the art and may comprise one single sealed edge typically the bottom edge a dispensing aperture at the top edge which may be provided by injection overmolding techniques and no additional perimeter edge seals or it may be an aerosol container. The handle (4) may be of any shape but is typically tubular as for example utilized in the cosmetics industry as squeeze tubes or conventional aerosol containers.

In order to contain the fluid and to enable the consumer to hold the reservoir in order to use the hair removal means and or fluid dispensing means in a controlled manner across all skin surfaces in both wet and dry environments, the hollow handle (10) may be provided from any material or combination of materials suitable to contain a fluid i.e. liquid impervious materials or composites and which is flexible, and preferably resilient provided as a single component. This enables the handle to provide the required both sufficient stiffness while retaining sufficient flexibility to be held securely by a user to utilize the device in a controlled manner without the need for a pump or push button activator or complex multicomponent parts. In one embodiment, the handle is formed from a polymer such as HDPE, MDPE, LDPE, PP, PET, PS, PC, PVC, PE or mixtures thereof, or laminates or other commercially available materials which are preferably capable of being blow or injection molded and or extruded. Alternatively the handle may be provided from a metal or alloy. The material may be selected depending on the internal capacity of the handle and the density and the volume of the fluid to be contained therein and the strength and flexibility required for the particular application. Suitable manufacturing techniques include blow molding, extrusion, injection molding and over molding and combinations thereof.

Typically the handle has a substantially uniform thickness as achieved by standard blow molding techniques of from about 0.05 mm to about 1 mm, preferably from about 0.07 mm to about 0.8 mm, more preferably from about 0.3 mm to about 0.6 mm

The handle material may be transparent or opaque; the latter may have a particular application to prevent fluid degradation, whereas the former enables the consumer to readily observe the consumption of the fluid. Embodiments with partial transparent or opaque portions are also envisioned. The outer surface of the handle and or chassis or at least a portion thereof such as the major front or rear surface(s) or portion thereof, may be coated or printed with an additional material to provide a consumer preferred tactile surface such as a woven, non woven, and or polymers such as silicone and rubber. In addition the outer surface of the handle and or chassis may be provided with indicia to communicate to the consumer information such as the contents of the handle, usage instructions, recommended handling position to hold and dispense the fluid.

Reservoir

The device may further comprise at least one sealed fluid reservoir (10), preferably a flexible reservoir, more preferably contained within the handle (4). The reservoir (10) may extend from proximal end (5) towards the distal end (6) of the handle and the head portion (9) and contains a fluid, paste or gel. The reservoir of the invention may be any suitable reservoir to contain fluids. Preferably the reservoir is a flexible reservoir for containing fluids which facilitates the expulsion of the fluid from the reservoir upon the application of pressure by the user. In one embodiment as discussed hereinabove the handle is provided with a hollow cavity which provides the fluid reservoir functionality.

The reservoir may have major front and back surfaces and at least one side edge, preferably the reservoir has two side edges and a top and a bottom edge. The edges may define the perimeter of the reservoir (10). The edges are preferably linear but may exhibit a degree of curvature for example at the respective corners. The fluid reservoir has a main body portion which contains the fluid. The at least one sealed edge, is preferably located on the top edge of the reservoir.

The fluid reservoir may be provided from any material or combination of materials suitable to contain a fluid i.e. liquid impervious materials or composites. In one embodiment the reservoir is formed from a polymeric film such as plastic films, and or laminated plastic films or composite materials such as for example: PET/VMPE, PET/Foil/PE (preferably metal foils for example aluminum), PET/LLDPE, PET/PE-EVOH-PE, or SURLYN™ or other commercially available materials which are preferably capable of being sealing, preferably by heat sealing techniques. The laminate films may be formed by any method known in the art such as heat, pressure and or adhesive. The material may be selected depending on the capacity of the reservoir and the density and the volume of the fluid to be contained therein and the strength and flexibility required for the particular application. The material may be transparent or opaque; the latter may have particular application to prevent fluid degradation, whereas the former may allow the consumer to determine the amount of fluid available for application to the skin. The outer surface of the reservoir or at least a portion thereof such as the major front or rear surface(s) or portion thereof, may be coated with an additional material to provide a consumer preferred tactile surface such as a woven, non woven, and or polymers such as silicone and rubber. In addition the outer surface of the reservoir may be provided with indicia to communicate to the consumer information such as the contents of the reservoir, usage instructions, recommended handling position to hold and dispense the fluid.

The reservoir (10) may be formed from a single sheet of material, which is folded and sealed, preferably heat sealed, at the top and bottom end edges and one side edge to form the reservoir. Optionally the second may be sealed to form a perimeter seal. In another embodiment, the reservoir may be formed from at least two sheets of material sealed along all the top, bottom, and side edges to form the reservoir. The edges of the reservoir are preferably substantially linear but may be partially curved. The reservoir may be sealed along all of its perimeter edges. Alternatively the reservoir may be formed by extrusion or blow molding techniques and may comprise one single sealed edge and no additional perimeter edge seals. The reservoir may be of any shape but is typically substantially rectangular, square, oval or circular, preferably substantially rectangular.

The reservoir (10) may comprise one or multiple i.e. two or more separate fluid compartments to enable different compositions to be applied and or to enable multiple applications of the same or similar fluid composition(s). Each separate fluid compartment will preferably have an opening means or tab associated with the reservoir as described hereinafter. The multiple compartments may be provided by forming a reservoir having one compartment which is divided into 2 compartments by the provision of an additional seal.

In certain embodiments the fluid reservoir may be attached to the handle (4) at least on a portion of one of the internal or external surfaces thereof. Any suitable means to attach the reservoir may be used such as adhesives, ultrasonic welding, double sided tape, rivets, clips or other mechanical means and combinations thereof.

In one embodiment, the fluid dispensing means may also function as the fluid reservoir. This is achieved by the selection of materials for the fluid dispensing means such as felt which is capable of providing the required fluid capacity and releasing the fluid only upon demand Such materials may additionally be in liquid communication with a fluid reservoir.

Capacity

The capacity of the fluid reservoir is selected dependent upon the end use and intended usage regime, in other words whether it is intended for single use or multiple use. For beauty and grooming applications, the fluid reservoir may have a capacity of from about 1 ml to 500 ml, preferably from about 1 ml to 100 ml, more preferably from 1 ml to 15 ml or from 10 ml to 25 ml. The fluid reservoir is typically filled to at least about 75%, preferably at least about 80% capacity to prevent inadvertent spillage upon opening.

Opening Means

The fluid reservoir may further be provided with an opening means to open said reservoir (10) or hollow handle to provide an aperture to thereby form a fluid communication between the reservoir (10) and the fluid dispensing means (3). Any suitable opening means may be used. The opening means may be a single use opening means or may be resealable to enable reuse of the reservoir. Suitable opening means include pull tab, pull string, foil loop, snap seals, piercer, and pressure burst seal and tear strip. Examples of a resealable opening means include sealed caps such as screw tops; adhesive tabs, hook and loop fasteners such as Velcro™, plastic zips such as Ziploc™, press seals, stopper caps or plugs, valves such as squeeze valves, duck bill valves, push valves and one way valves, and other types of commercially available sealing methods as found on drink containers for example and known to the skilled person.

The opening means may be configured such that it is associated with the movement of the head portion from its storage to its in use configuration so that the reservoir is open and in fluid communication with the fluid dispensing means when the device is in its in use configuration and preferably the reservoir is sealed when the device is in its storage configuration.

In one embodiment, the in use configuration attachment means may function as an opening means, whereby upon docking the head portion onto the handle the reservoir is opened.

In yet another alternative embodiment, the opening means may be provided as a separate component to the hair removal and fluid application device (1) such as an implement designed to break or pierce the seal.

In one embodiment the reservoir is provided with at least one sealed edge having two surfaces and an opening means is releasably attached in between said two surfaces and extends outwardly there from. Upon removal of said opening means (11) by the user, an opening is formed in the sealed edge to enable the user to dispense the fluid contained in the reservoir (10).

The fluid reservoir (10) may be further provided with an opening means or tab to open the sealed edge or aperture of the reservoir. The opening means or tab may be readily grasped by the consumer, typically at its distal end or by the tag, if present, to initiate the opening process. Typically, the consumer will pull on the opening means generally in a direction away from the reservoir and thereby rupture a portion of the sealed edge or aperture to create an opening upon removal or partial removal of the opening means there from. The fluid contained in the reservoir may then be dispensed by the user.

Accordingly, the opening means may be releasably attached in-between the two contacting surfaces which are sealed to provide the at least one sealed edge of the fluid reservoir and extends outwardly there from. The opening means or tab may have a proximal end and a distal end, wherein at least a portion of the proximal end is releasably attached in between the two contacting surfaces of the sealed edge and the distal end extends outwardly there from. Any means may be used to releasably attach the opening means to the two surfaces of the sealed edge or aperture including but not limited to adhesives, heat and pressure sealing, heat sealing being preferred. The opening means is typically positioned in-between the two adjacent surfaces prior to sealing to form the sealed edge as discussed hereinafter. The sealed edge containing the opening means is preferably provided in the top sealed edge of the reservoir.

The opening means may be provided from any suitable material such as the same or different material or film used for the reservoir material as described hereinabove. Suitable materials include but are not limited to metal, cotton, polymers such as polyester, nylon, rayon, plastics, cellulose based materials such as cardboard and paper which may be laminated, coated or waxed. The opening means may be flexible or rigid.

The opening means may have any suitable size, shape and geometry provided that it can be releasable attached in between the two surfaces of the sealed edge and can be easily grabbed by the fingers of the consumer. Preferably the opening means is substantially flat. For beauty and grooming applications, the opening means or tab may have a width of from about 0.1 mm to 2.5 cm, preferably from about 0.5 mm to 1 cm and a length of from about 1 cm to 15 cm, preferably from about 2 cm to about 10 cm. Alternative applications may however require dimensions of from 2 cm to 10 cm in width and 10 cm to 50 cm in length. The distal end of the opening means, which extends from the seal and is clearly visible to the consumer, may be symmetrical or unsymmetrical, uniform or non uniform cross section.

The opening means may comprise a single tab, string or thread which extends from said at least one sealed edge or aperture and terminates at a point distal there from. Alternatively, the opening means may be a tab, string or thread which extends from said at least one sealed edge to form a loop. In such embodiments, the proximal end of the loop may be releasably attached at said at least one sealed edge. The distal end may also be attached in-between the two surfaces of the sealed edge or attached at the exterior surface of the sealed edge or at the front or back surface of the reservoir or attached to a portion of the distal end of the opening means. In one embodiment, both the proximal and distal ends are releasably attached in between the two surfaces of the sealed edge. In one embodiment, the tab may be provided with at least 2, preferably at least 3, more preferably at least 4 tines, in at least a portion of the proximal end of the opening means.

The tines may be present in the portion of the proximal end in between the two surfaces forming the sealed edge and may extend into the interior cavity of the reservoir. The tines if present may also extend into a portion of the distal end. The tines may assist in the creation of a more uniform opening or where desirable the creation of more than one opening upon removal of the opening means from the reservoir. Such multiple openings may assist in a more uniform distribution of the fluid upon dispensing from the reservoir onto a surface.

For embodiments where the opening means or tab terminates at a point distal from the sealed opening, the tab may further comprise a tag attached thereto. The tag is preferably substantially wider than the distal end of the opening means or tab to provide a larger surface area for the consumer to grasp and subsequently pull and remove or at least partially detach the opening means from the sealed edge. In an alternative embodiment, the tag may be in the form of a loop attached to the distal end of the opening means to enable the consumer to grasp and pull on the opening means. The tag may be any shape and preferably have a width or diameter of at least 0.1 mm, preferably at least 2 mm, more preferably at least 5 mm, even more preferably from 2 mm to 40 mm, most preferably from 5 mm to 20 mm. The width may be uniform or it may be tapered. For embodiments wherein the distal end of the opening means is in the form of a loop, such a tag may be provided at substantially the midpoint of the loop to provide additional assistance to the consumer to grasp the opening means. For embodiments wherein the opening means is a string or thread, the tag may be formed by providing a knot or loop at the distal end of the opening means. The tag may be provided from the same or different material as the opening means. In one embodiment the tag is formed from a different material preferably so as to provide a consumer preferred tactile surface.

The opening means or tab may be provided in an unfolded or folded configuration, which may be held in place by the tab if present and is unfolded prior to use.

The opening means or tab and or tag may be provided with indicia to indicate to the consumer, the location of the tab, and or the preferred gripping location and or the direction to pull the means or tab to open and at least partially detach or remove the tab from the reservoir. Indicia may be in the form of differentiated colors and or symbols.

A portion of the proximal end of the opening means or tab may extend beyond the at least one sealed edge into the interior cavity of the reservoir. Such embodiments may further ensure the attachment of the opening means in between the two surfaces of the sealed edge. The opening means or tab located in the interior cavity of the reservoir may have the same or different shape as the distal portion of the opening means or tab which extends outward from the reservoir. In one embodiment, the portion of the proximal end which extends into the cavity of the reservoir is in the form of a loop. In such embodiments, the distal end of the opening means extending from the sealed edge may or may not also be in the form of a loop.

The portion of the proximal end of the opening means that extends into the interior cavity of the reservoir may be attached or partially releasably attached to the interior surface of the reservoir.

For embodiments wherein the opening means is a loop, the distal portion may also extend into the reservoir interior.

In one embodiment, the portion of the proximal end of the opening means or tab in the interior cavity of the reservoir has a width which is larger than the portion of the proximal end of the opening means in between the two surfaces at the sealed edge. Alternatively, the portion of the proximal end of the opening means in the interior cavity may be larger than the distal portion of the tab extending outward from the sealed edge. While not being bound by theory it is believed that increasing the width of portion of the proximal end of the opening means in the interior cavity of the reservoir results in a greater force being exerted upon the sealed edge as the consumer pulls on the distal end of the opening means. This thereby further improves the opening of the seal upon removal or partial removal of the opening means from the reservoir and optionally also may remove any debris present such as adhesive. The portion of the proximal end of the opening means or tab which extends into the interior cavity of the reservoir may be provided from a different material to that portion in-between the edge seal or the proximal end extending outward there from. The material will be selected to be inert towards the fluid contained within the reservoir. For embodiments wherein the distal end is provided by a string or thread, the width may be increased by the provision of knots or at least one tag.

In another embodiment, the opening means or tab may be tapered in at least a portion, preferably all of the distal and or proximal ends. The opening means may be tapered at least in the portion of the proximal end releasably attached in between the two surfaces of the sealed edge. The opening means may therefore have a width in a portion of the proximal or distal end that is larger than the portion of the proximal end of the opening means positioned between the two surfaces forming the sealed opening Similarly, a portion of the proximal end of the opening means may have a width which is larger than the width of the portion of the proximal end positioned between the two surfaces of the sealed edge. The tapering may be linear or curved so as to provide an hour glass or arrow head shape for example. This is of particular advantage for embodiments wherein the proximal end extends into the cavity of the reservoir. Upon exertion of force to remove the opening means the portion of the proximal end thereof located in the reservoir cavity having a width larger than the width of the portion of the proximal end located in between the two surfaces of the sealed edge will be forced against the sealed edge and cause the seal to be ruptured, thereby creating an opening and or enlarging the opening(s).

The opening tab may be positioned at any position along the at least one sealed edge. Preferably the opening tab is located at substantially the midpoint of said sealed edge, but may be located at a position to the left or right of the midpoint or at or towards the corner of the sealed edge.

In one embodiment wherein the opening means or tab is provided in the form of a loop wherein the distal and proximal ends are releasably attached in between the two surfaces of the sealed edge, the opening means and reservoir are preferably provided from the same or substantially similar material as the reservoir. Such material may preferably be provided with different properties for each surface which may be readily provided by laminate materials to enable heat sealing. The outer surface of loop laminate which contacts the inner surface of the sealed edge is selected such that it will weakly adhere to the surface of the laminate film of the reservoir at the sealed edge. While not being bound by theory it is believed that this results in a seal that requires less force to be opened upon removal or partial removal of the opening means upon the application of force. This is particularly advantageous for multi-layered composite films, for example (PET/VMPE) and other commercially available films.

In addition to releasably attaching a portion of the proximal end of the opening means in between the two surfaces of the sealed edge of the reservoir, a portion of the distal or proximal end of the opening means may have at least one additional attachment, preferably a releasable attachment to the reservoir. Such an attachment may be on an external or internal surface of the reservoir. Embodiments wherein the opening means and or the reservoir utilize laminate materials utilizing adhesives in their manufacture this may find particular utility to form such an attachment. While not bound by theory, it is believed that the adhesive may seep from the laminate particularly due to the application of heat and or pressure around the perimeter sealed edges and or edges of the opening means and thereby result in additional attachment.

Neck Portion

In one preferred embodiment, the reservoir or handle preferably if the handle is providing a hollow cavity acting as the fluid reservoir comprises a main body which is further provided with a neck portion extending there from. The presence of a neck portion enables improved fluid flow control and may also enable improved connection with the head portion to which the reservoir and or handle is attached. The at least one sealed edge or aperture may be located in the body portion of the reservoir or handle or it may be located in the neck portion. Preferably the at least sealed edge or aperture is located in the neck portion, if present. The top and side edges of the reservoir if present will extend from the body to neck portion respectively.

The neck portion is preferably located substantially at the midpoint of the width of the body portion extending from the top edge thereof. Alternative configurations include embodiments where the neck portion is offset from the midpoint or located towards one of the upper corner edges of the body portion. The neck portion may extend a length of up to 50% of the length of the side edge of the body portion. In such embodiments the side edges of the reservoir may extend from the body potion to form the side edges of the neck portion and similarly the top edge or a portion of the top edge of the reservoir may be located in the neck portion. Preferably the neck portion has a width less than the width of the body of the reservoir, preferably less than 75%, preferably less than 50%, more preferably less than 40% of the width of the body portion of the major front or rear surface of the reservoir.

The neck portion may have any suitable shape and may be symmetrical or unsymmetrical and is preferably selected to enhance the flow of fluid towards the opening. The neck portion may have substantially linear sides or curved sides which may be substantially vertical or at a gradient to provide a tapered neck which aids in the funneling of the fluid out of the reservoir.

In a preferred embodiment the opening means extends from the reservoir through the fluid handle (4) and or fluid dispensing means (3) at least to the front surface of the device so that the distal end or tag can be readily accessed by the consumer. In such embodiments the fluid dispensing means (3) may be provided with at least one aperture or opening sized to enable the opening means to be passed through the fluid dispensing means (3). Such opening may also function to deliver the fluid to the skin from the reservoir.

For embodiments wherein the fluid reservoir and or handle are preferably provided with a neck portion, the neck portion may extend towards the fluid dispensing means and even more preferably extends at least a portion within or onto or through the fluid dispensing means via an opening or aperture and thereby create a fluid pathway between the fluid reservoir and the fluid dispensing means. The opening means is typically located in the neck portion if present.

The fluid dispensing means has at least one fluid pathway in fluid communication with the opening means and the reservoir. For embodiments wherein the handle is positioned between the fluid reservoir and the fluid dispensing means, the handle may be provided with an opening through which a portion of the reservoir at least partially extends through. Alternatively the fluid reservoir may extend around the handle to access the fluid dispensing means.

Cap/Cover

The hair removal and fluid application device may further comprise a cap(s) and or cover (s)(14) and or disposable seal or release liner to protect the hair removal means and or fluid dispensing means prior to use, during use and after use for multiple use embodiments. Any suitable cap or seal may be used such as flow wraps. The cover may in addition completely cover and enclose the device. The cap may be provided in the same material as described for the handle or a different material. The cap or cover may be integrated with the handle or separate there from. The cap may also assist in maintaining the head portion in its storage configuration.

In one embodiment the cover may also be provided with one surface which is provided from a material such as a non woven. The surface can be used to wipe the skin surface before or after fluid application and or hair removal. The surface may be impregnated with skin actives and or skin cleaning actives. The other surface typically protects the hair removal and fluid application means.

Fluid

The reservoir comprises a liquid, gel or paste which may comprise skin and or shaving care actives and or hair removal or depilatory compositions. The compositions may be aqueous, water in oil or oil in water emulsions.

It has been found that when selecting a composition to be used in hair removal devices, it can be particularly desirable to select a composition which is sufficiently thick and viscous that it will not run off the skin or razor after being dispensed. Additionally, moisturizing compositions can be desirable for use in a fluid dispensing hair removal device to allow for multiple benefits, including but not limited to hydration of the hairs prior to shaving, moisturization of skin during the hair removal process, lubrication of skin to reduce friction during the shave, and so forth. Those of skill in the art will understand that moisturization can include hydration of the skin or hair or occlusion of the skin and or hair, or lubrication of the hair or skin to increase glide and reduce friction between the fluid dispensing device and skin.

Water

The shave care composition of the current invention comprises water. In one embodiment, the shave care composition comprises at least about 30% by weight water. In an alternate embodiment, the shave care composition comprises at least about 40% by weight water. In an alternate embodiment, the shave care composition comprises at least about 50%, more preferably at least 60%, even more preferably at least 80% and even more preferably at least 90% by weight water. Compositions having high levels of water enable the device to be used without the necessity for an additional water source to apply or remove the composition from the skin after application.

Lipophilic Skin Conditioning Agent

Shave care composition of the present invention may comprise one or more lipophilic skin conditioning agents. The concentration level of the skin conditioning agents either singularly or collectively may range from about 1% to about 50% by weight of the base composition, preferably about 10% to about 40%, and more preferably from about 13% to about 30%. Exemplary skin conditioning agents include hydrocarbons, polymeric hydrocarbons, esters, ethers, and silicones selected from the group consisting of alkyl ethers, mineral oil, isoparaffin, greater than C20 hydrogenated polyisobutene; and an ester composed of a branched C16-C22 alkyl chain and a mono alkyl group consisting of a linear or branched C1 to C6 alkyl chain. Some preferred skin conditioning agents comprise isostearic acid derivatives; for example, isostearyl isostearate, isopropyl isostearate, isopropylpalmitate, isopropylmyristate, PPG-15 Stearyl Ether, petrolatum, dimethicone and dimethoconol and mixtures thereof.

In one embodiment, two or more hydrocarbon phases are preblended prior to emulsification. It has been found that pre-blends of such ingredients can lead to improved skin feel. Examples include petrolatum blended with mineral oil or isopropylpalmitate.

The skin conditioning agents may also help to reduce the coefficient of friction for compositions provided herein. The reduction in friction can decrease the potential for skin irritation that can arise from contacting the skin one or more times with a hair removal device such as a razor blade. Employment of the skin conditioning agent in this context may also permit formulation flexibility regarding the type and concentration level of lubricants that are included in the shaving preparations.

In one embodiment of the invention, particle size of the dispersed phase skin conditioners has an average particle size of 95% of the dispersed phase mass below 20 microns, preferably below 15 microns, more preferably below 10 microns and most preferably below 5 microns. Particle size as measured using a Horiba particle size analyzer and reported as D 50 values. While not wishing to be bound by theory, the smaller particle size is very important for the dispersed phase skin conditioners to be retained on the skin during shaving especially when the shaving composition is dispensed in front of the razor blades or upon re-stroke of the razor when the composition has been deposited on the skin. It is recognized that the skin is not a flat surface and smaller particles can deposit and reside in the recessed areas of the skin and around the hair follicle more easily than larger particles.

Thickening Agent

The fluid composition may contain one or more thickening agents, from about 0.1% to about 5%, alternatively from about 0.1% to about 4%, alternatively from about 0.25% to about 3%, by weight of the composition.

Non limiting classes of thickening agents include those selected from the following: Carboxylic Acid Polymers, Crosslinked Polyacrylate Polymers Polyacrylamide Polymers, Polysaccharides, Clays and Gums, and mixtures thereof when appropriate. In one embodiment, compositions of the present invention include a thickening agent selected from carboxylic acid polymers, crosslinked polyacrylate polymers, polyacrylamide polymers, polysaccharides, and mixtures thereof, more preferably selected from carboxylic acid polymers, polyacrylamide polymers, polysaccharides, and mixtures thereof.

Preferred thickening/suspending agents include electrolyte sensitive polymers that are shear thinning when in solution. Shear thinning is property that makes a liquid easy to spread and pump. We have found that electrolyte sensitive polymers have desired performance profiles. While not wishing to be bound by theory, the electrolyte sensitive polymers interact with the residual surfactant or electrolyte left on the skin and release the lubrication agents and/or suspended conditioning agents for spreading across the razor and across the surface of the skin. Preferred electrolyte sensitive polymers include but are not limited to: Polyacrylamide, Hydroxyethyl Acrylate/Sodium Acryloyldimethyltaurate Copolymer, Sodium Acrylate/Sodium Acryloyldimethyl Taurate Copolymer, Ammonium Polyacrylate, Sodium Acrylate/Acryloyldimethyltaurate/Dimethylacrylamide Crosspolymer, Hydroxyethyl Acrylate/Sodium Acryloyldimethyltaurate Copolymer which can be purchased from Seppic or Carboxylic Acid Polymers (Carbomers) such as Ultrez 10, Carbopol 934, Carbopol 980 and ETD 2050 which can be purchased from Lubrizol or Ammonium Acryloyldimethyltaurate/VP Copolymer, Sodium Acryloyldimethyltaurate/VP Copolymer, Ammonium Acryloyldimethyltaurate/Beheneth-25 Methacrylate Crosspolymer, which can be purchased from Clariant. The most preferred electrolyte sensitive polymer is Polyacrylamide available as Sepigel 305 (Polyacrylamide & C13-14 Isoparaffin & Laureth-7).

Emulsifier

The fluid composition may contain one or more emulsifying agents, from about 0.1% to about 20%, alternatively from about 0.5% to about 15%, alternatively from about 1.0% to about 12%, by weight of the composition. Non limiting examples of surfactants for emulsification for use herein are disclosed in McCutcheon's, Detergents and Emulsifiers, North American Edition (1986), published by Allured Publishing Corporation; and McCutcheon's, Functional Materials, North American Edition (1992). Preferred emulsifiers are nonionic surfactants/emulsifiers. Non limiting useful emulsifiers herein include those selected from the group consisting of alkyl glucosides, alkyl polyglucosides, polyhydroxy fatty acid amides, alkoxylated fatty acid esters, sucrose esters, alkoxylated fatty alcohols, amine oxides, and mixtures thereof. Most preferred are alkoxylated fatty alcohols and alkyl glucosides and mixtures thereof.

In one embodiment the fluid composition comprises less than about 5%, or less than about 3%, or less than about 2% of one or more lathering surfactants. In one embodiment the fluid is free or substantially free of lathering surfactants. A lathering surfactant is defined as a surfactant which when combined with water and mechanically agitated generate a foam or lather. Lathering surfactants include anionic and amphoteric lathering surfactants and mixtures thereof. Anionic lathering surfactants include sarcosinates, sulfates, sulfonate, isethionate, taurates, phosphates, lactylates, glutamates, alkali metal salts of fatty acids (i.e. soaps) having from 8 to 24 carbons, and mixtures thereof.

Lubricants

The fluid compositions may employ one or more lubricants, from about 0.1% to about 8%, alternatively from about 0.1% to about 5%, alternatively from about 0.2% to about 3%, by weight of the composition. Exemplary lubricants include lubricous water soluble polymers, water insoluble particles, and hydrogel-forming (or water swellable) polymers, and mixtures thereof.

Useful lubricious water soluble polymers may have a molecular weight greater between about 300,000 and 15,000,000 Daltons, preferably more than about one million Daltons. Nonlimiting examples of suitable lubricious water soluble polymers include polyethylene oxide, polyvinylpyrrolidone, and polyacrylamide. Non limiting useful water insoluble particles may include inorganic particles or organic polymer particles. Hydrogel-forming polymers are typically highly hydrophilic polymers that, in water, form organized three-dimensional domains of approximately nanometer scale. Additional polymer lubricants include: cellulose derivatives such as hydroxyalkyl cellulose polymers such as hydroxyethyl cellulose and hydroxypropyl cellulose, carboxymethyl cellulose, and cellulose methyl ether and polysaccharide gums such as, for example, xanthan gum, carrageenan gum, guar gum, locust bean gum, and hydroxypropyl guar gum.

Sensates

In one embodiment of the invention, the composition may contain sensates, or combinations of sensates. Sensates can be materials that provide the sensation of a thermal change, e.g., heating or cooling. Applicants have found that the addition of sensates using this composition provides longer lasting skin sensation and comfort benefits. Non-limiting examples include: p-Methane-3,8-diol; Isopulegol; Menthoxypropane-1,2,-diol; Curcumin; Menthyl Lactate; Gingerol; Icilin; Menthol; Tea Tree Oil; Methyl Salicylate; Camphor; Peppermint Oil; N-Ethyl-p-menthane-3-carboxamide; N-[4-(Cyanomethyl)phenyl]-2-isopropyl-5-methylcyclohexane-carboxamide; Ethyl 3-(p-menthane-3-carboxamido)acetate; 2-Isopropyl-N,2,3-trimethylbutyramide; Menthone glycerol ketal, and mixtures thereof.

Gel Network

The fluid composition is preferably substantially free from a gel network phase. As used herein, the term “gel network” refers to a lamellar or vesicular solid crystalline phase which comprises at least one fatty amphiphile. The present invention contains less than about 3%, alternatively less than about 1%, alternatively less than about 0.5% of at least one fatty amphiphiles. Gel networks have been found to reduce the rinse profile of these systems. Fatty alcohol gel networks have been used for years in cosmetic creams and hair conditioners. Gel networks are a re-solidified liquid crystal gel phase formed by fatty amphiphiles (e.g. cetyl or stearyl alcohol) and a hydrophilic phase (e.g. water). It is formed by undergoing a melting and then re-solidification process in the hydrophilic phase. The gel network will typically have a lower thermal transition than the melt temperature of the fatty amphiphile itself.

Optional Ingredients

The fluid composition may further comprise additional optional ingredients. Suitable additional optional ingredients include perfume, preservatives, chelants, sensates (e.g. menthol), desquamation actives, anti-acne actives, anti-wrinkle/anti-atrophy actives, anti-oxidants/radical scavengers, flavonoids, anti-inflammatory agents, anti-cellulite agents, topical anesthetics, tanning actives, skin lightening agents, skin soothing and healing actives, antimicrobial actives, sunscreen actives, visual skin enhancers, humectants and moisturizing agents (e.g., glycerin, glycols, sorbitol) and the like. Such optional ingredients are described more fully in U.S. application Ser. No. 11/367,918, filed Mar. 3, 2006. Preferred additional optional ingredients include salicylic acid, opacifiers (e.g. mica and titanium dioxide), perfume, hydrophilic conditioning agents (e.g., glycerin) and skin sensates (e.g. menthol).

The fluid composition may contain salicylic acid, its isomers, tautomers, salts and derivatives thereof. Alternatively, the compositions comprise from about 0.001% to about 5% salicylic acid. Alternatively, the compositions comprise from about 0.01% to about 2% salicylic acid. Alternatively, the compositions comprise from about 0.1% to about 1% salicylic acid. Without wishing to be bound by theory, it is believed that salicylic acid is efficacious for the treatment of acne on the skin. Moreover, the salicylic acid is capable of treating and/or reducing the presence of acne on the skin. Such treatment with the shave care composition of this invention involves applying the shave care composition to the skin via the razor and shaving the skin that has been treated with the shave care composition.

Derivatives of salicylic acid include, but are not limited to, any compounds wherein the CH3 groups are individually or in combination replaced by amides, esters, amino groups, alkyls, and alcohol esters. Tautomers of salicylic acid are the isomers of salicylic acid which can change into one another with ease so that they ordinarily exist in equilibrium. Thus, tautomers of salicylic acid can be described as having the chemical formula C7H6O3 and generally having a similar structure to salicylic acid.

The compositions of the present invention may include from about 0.001% to about 5%, alternatively from about 0.01% to about 2%, and alternatively from about 0.1% to about 1%, of alpha- or beta-hydroxy acids, and derivatives, salts, isomers and tautomers thereof. Non-limiting examples of alpha- and beta-hydroxy acids include alpha-hydroxy-butyric acid, alpha-hydroxyisobutyric acid, alpha-hydroxyisocaproic acid, alpha-hydroxyisovaleric, atrolactic acid, beta-hydroxybutyric acid, beta-phenyl lactic acid, beta-phenylpyruvic acid, citric acid ethyl pyruvate, galacturonic acid, glucoheptonic acid, glucoheptono 1,4-lactone, gluconic acid, gluconolactone glucuronic acid, glucuronolactone, glycolic acid, isopropyl pyruvate, lactic acid, malic acid, amndelic acid, emthyl pyruvate, mucic acid, pyruvic acid, saccharic acid, saccharic acid 1,4-lactone, tartaric acid and tartronic acid, and mixtures thereof.

Opacifiers may be added to the shave care composition of the present invention. Opacifiers may be either inorganic or organic compounds. Inorganic opacifiers include, for example, titanium dioxide, zinc oxide, talc, mica or coated mica (with oxides of titanium, tin, or iron or bismuth oxychloride), magnesium aluminum silicate, bismuth oxychloride, or other minerals. These compounds can be added as powders, dispersions, or complexes. Organic opacifiers include, for example, opaque emulsions (e.g., containing Styrene/PVP copolymer, vinyl polymers, or latexes), metal salts of amines containing 14-20 carbon atoms per molecule, alkanolamides containing 14-20 carbon atoms per molecule, organic alcohols containing 14-20 carbon atoms per molecule, insoluble salts of stearic acid, glycol mono-or distearates, propylene glycol and glycerol monostearates and palmitates. Combinations of these opacifiers can also be used. The opacifying additive is typically included in an amount of about 1 to about 6%, preferably about 2 to about 5%, by weight of the composition.

The fluid compositions may include depilatory actives including any keratin reducing agents such as sulphide salts, thioglycol, thioglycerol, thioglycomide, thioglycolhydrazide thioglycolic acid, thioglycolate salts such as potassium, calcium and ammonium, thiosalicylic acid, thiomalic acid, ammonium thiolactic acid, cysteine and cysteamine. The reducing agent is present at amounts of from about 0.1% to 20%, preferably 0.2% to 15%, more preferably from 0.5% to 10% by weight of the composition. Preferably the depilatory composition may further comprise a base to control pH such as sodium or potassium hydroxide, ammonia alkanolamides such as monoethanolamide and mixtures thereof.

### Specific Embodiments

The invention will now be further described with reference to specific embodiments of the invention.

FIGS. 1a, 1b and 2 and 3a and 3b show a first embodiment of the invention. This embodiment comprises a head portion (9) on the distal end of the handle (4) comprising a hair removal means (2) comprising at least one razor blade on the front surface of the head portion (9). A fluid dispensing means (3) is located on the back surface of the head portion whereby the skin contacting surface of the hair removal means and fluid dispensing means are positioned in substantially opposing directions. The hair removal means (2) and the fluid dispensing means (3) are arranged in a predetermined position such that they are located in opposing directions facing the respective skin contacting surfaces in both the in storage and in use configuration. The fluid dispensing means (3) comprises a sponge which extends substantially across the entire width of the head portion. The hair removal means extends substantially across the entire width of the head portion. The hair removal means (2) and fluid dispensing means (3) are secured to the head portion (9) which is secured to the handle (4) about a pivot point (12). The head portion has a recess (13) cavity extending from one end of the head portion to the pivot point so that a section of the head portion (9) can be contained by the handle (4) when the device is in its storage configuration and can rotate by about 90° to its in use configuration.

The handle (4) is a pressurized aerosol container which acts as the reservoir and dispenser of the liquid. Upon activation of the aerosol a liquid pathway from the hollow handle (4) reservoir to the fluid dispensing means (3) is provided. The head portion (9) is protected by a cover (14) which can be unwrapped and function as a wipe.

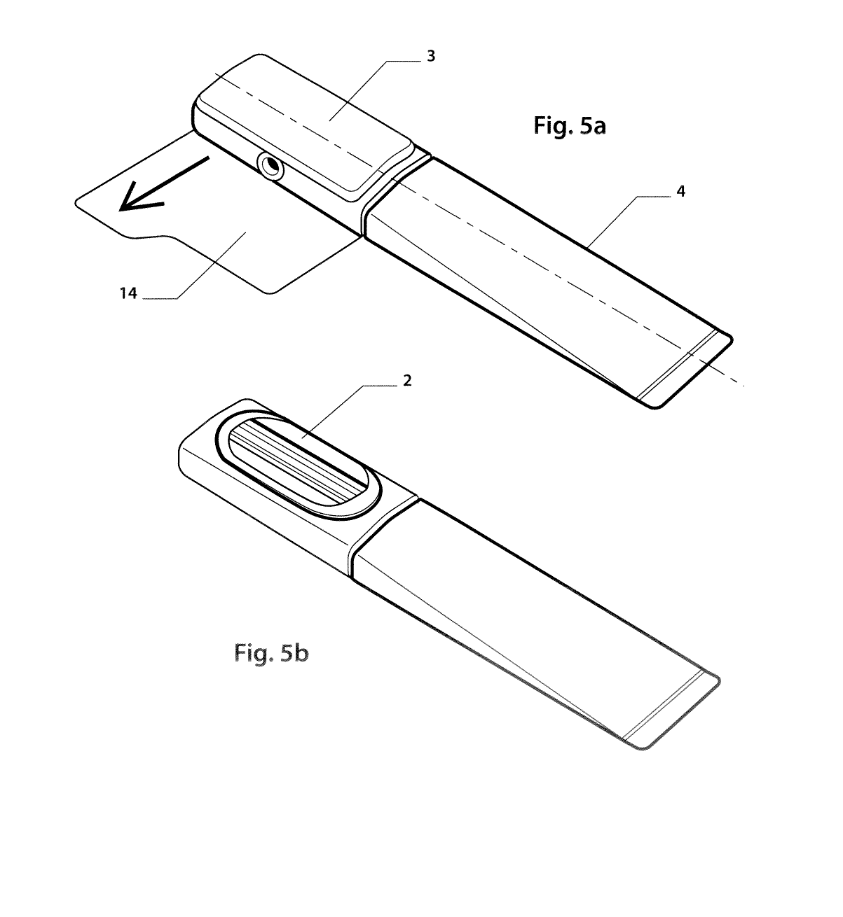

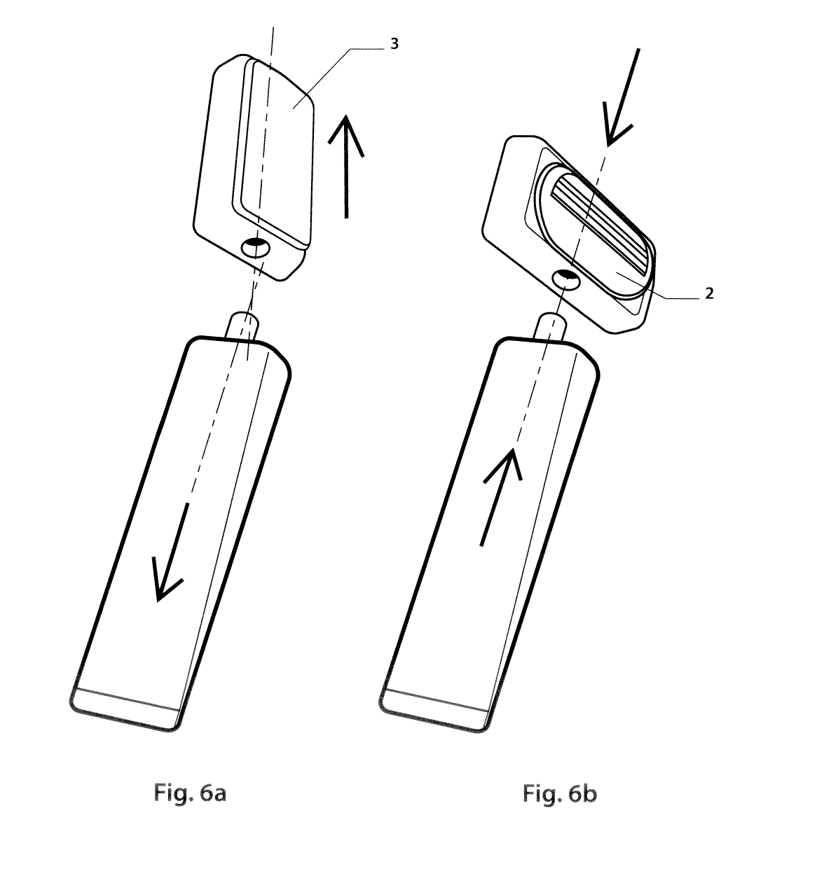

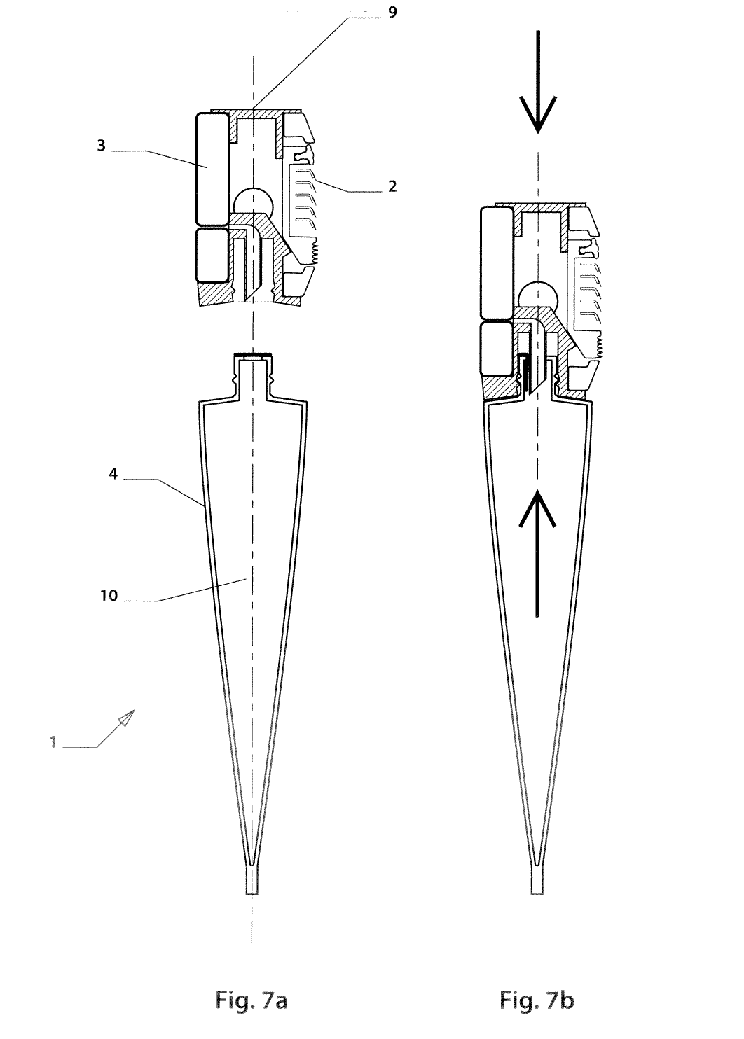

FIGS. 4a, 4b, 5a, 5b, 6a, 6b, 7a and 7b show a second embodiment of the invention. This embodiment comprises a head portion (9) having hair removal means (2) comprising at least one razor blade provided in a housing located on the front surface of the head portion (9). A fluid dispensing means (3) is located on the rear surface of the head portion whereby the skin contacting surface of the hair removal means and fluid dispensing means are positioned in substantially opposing directions. The hair removal means (2) and the fluid dispensing means (3) are arranged in a predetermined position such that they are located in opposing directions facing the respective skin contacting surfaces. The fluid dispensing means (3) comprises a sponge/felt which extends substantially across the entire width of the head portion. The hair removal means extends substantially across the entire width of the head portion. The hair removal means (2) and fluid dispensing means (3) are permanently secured to the head portion (9). The handle (4) is provided as a seamless extruded tube and is attached to the head portion via a screw thread on the neck portion of the handle formed from injection overmolding of the handle. The handle (4) is provided with a sealed opening through which a liquid pathway to the fluid dispensing means (3) is formed. The head portion (9) has a storage configuration attachment means and an in use configuration attachment means. The head portion is releaseably attached to the handle in the in storage and in use configuration means by a handle attachment means. The head portion is protected by a protective cover (14).

Method of Use

The hair removal and fluid dispensing devices of the invention provide a simple and convenient method to effectively remove hair from the body. The device is provided to the consumer in its storage configuration. The consumer typically, removes any cap or release layer or cover present to protect the hair removal means or fluid dispensing means. The consumer then positions the head portion of the device from its storage position to its use configuration. This may be achieved by for example by rotating the head portion about its pivot point to the in use position or by removing the head portion from its storage configuration and placing the head portion onto the handle in its in use configuration. The consumer then opens the fluid reservoir and removes the opening means there from. Alternatively the fluid reservoir may be opened by the rotation by the consumer from the storage configuration to the in use configuration. In an alternative embodiment the consumer detaches the head portion from the handle in its storage configuration, opens the reservoir and reattaches the head portion in its in use configuration on the handle. Optionally the consumer may apply pressure against the fluid reservoir to facilitate the flow of fluid from the reservoir to the fluid dispensing means. The consumer may treat the skin surface with the hair removal means in a first step and then apply fluid or firstly apply the fluid from the fluid dispensing means to the skin surface and then apply the hair removal means. For example the consumer may place the fluid dispensing means on the skin surface to be treated and apply the fluid using the dispensing means to the surface to be treated. The device is then optionally rotated so that the hair removal means is in contact with skin surface to be treated. The consumer applies the hair removal device to the same surface to remove the hair. The process is then repeated on the same or additional surfaces until the desired fluid application and hair removal is achieved. In addition the consumer may position and apply the fluid dispensing means over the same surface after the hair removal step in order to collect and remove any debris or excess composition from the skin surface. Alternatively, the consumer may utilize the hair removal means first before the fluid dispensing means, which may be used to deliver after shave composition. Once the consumer has completed the hair removal activity, the head portion is rotated to its storage configuration and the cap or wrap if present may optionally be reattached. The hair removal and fluid dispensing device of the present invention does not require a source of water in order to function, in particular the skin does not require wetting or the application of any pre and or post shave composition. Moreover the device does not require any post use rinsing.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A portable hair removal and fluid application device having a head portion comprising a hair removal means and a handle having a fluid reservoir and a fluid dispensing means wherein said head portion has a storage configuration and an in use configuration, wherein in said storage configuration said head portion is positioned adjacent said handle and substantially parallel thereto and in said in use configuration said head portion is positioned substantially perpendicular to said handle.

2. The portable hair removal and fluid application device according to claim 1, wherein said head portion is movably attached to said handle about a pivot point.

3. The portable hair removal and fluid application device according to claim 2, wherein said head portion is rotatable about a pivot point located on said handle to rotate said head portion between said in use configuration and said storage configuration.

4. The portable hair removal and fluid application device according to claim 3, wherein said pivot point is positioned at substantially the longitudinal midpoint of said head portion.

5. The portable hair removal and fluid application device according to claim 1, wherein said handle has a distal end and a proximal end and said head portion is movably attached to said distal end of said handle and said distal end at least partially contains said head portion in said storage configuration.

6. The portable hair removal and fluid application device according to claim 1, wherein said head portion is releasably attached to said handle.

7. The portable hair removal and fluid application device according to claim 6, wherein said head portion has an in use configuration attachment means and a storage configuration attachment means.

8. The portable hair removal and fluid application device according to claim 1, wherein said fluid dispensing means is located in said head portion.

9. The portable hair removal and fluid application device according to claim 8, wherein said head portion provides a predetermined location of said hair removal means and said fluid dispensing means.

10. The portable hair removal and fluid application device according to claim 8, wherein said head portion comprises a front surface and a back surface, wherein said front surface comprises said hair removal means and said back surface comprises said fluid dispensing means.

11. The portable hair removal and fluid application device according to claim 1, wherein said handle is substantially rigid.

12. The portable hair removal and fluid application device according to claim 1, wherein said reservoir comprises an opening means.

13. The portable hair removal and fluid application device according to claim 1, wherein said hair removal means comprises a blade and cartridge.

14. The portable hair removal and fluid application device according to claim 1, wherein said fluid dispensing means is selected from foams, wovens, nonwovens; apertured or perforated films, plastics, felt and combinations thereof;

15. The portable hair removal and fluid application device according claim 1, wherein said reservoir is in fluid communication with said fluid dispensing means in said in use configuration.

16. The hair removal and fluid application device according to claim 1, wherein said fluid dispensing means has at least one aperture in fluid communication with said reservoir.

17. The hair removal and fluid application device according to claim 1, wherein said reservoir comprises a composition comprising at least 80% by weight water and from 0.1% to 5% by weight of a thickening agent.

18. The method to apply fluid and remove hair from the skin with a device according to claim 1, comprising the steps of positioning said device in its in use configuration and then contacting a skin surface first with said hair removal means to remove hair and then with said fluid dispensing means to apply fluid or vice versa, preferably in the absence of a source of water.
